(19) United States
(12) Patent Application Publication
(10) Pub. No.: US 2024/0242913 A1
(43) Pub. Date: Jul. 18, 2024

(54) METHOD FOR PROTECTING REACTIVE MATERIALS WITH ATOMICALLY THIN FILM

(71) Applicant: Cornell University, Ithaca, NY (US)

(72) Inventors: Melissa A. Hines, Ithaca, NY (US); William J.I. De Benedetti, Ithaca, IN (US)

(21) Appl. No.: 18/559,491

(22) PCT Filed: May 6, 2022
(86) PCT No.: PCT/US2022/028091

§ 371 Date: Nov. 7, 2023

Related U.S. Application Data
(60) Provisional application No. 63/185,407, filed on May 7, 2021.

(51) Int. Cl. H01J 1/34

(52) U.S. Cl. CPC H01J 1/34; H01J 2201/3423; H01J 2209/02

(57) ABSTRACT

A method of forming a multi-layer structure comprising may include a step of providing a substrate, a step of depositing a protection layer, a step of depositing a thin film material, and a step of detaching. The substrate may have a low surface energy surface or a low surface energy coating or modification disposed on at least a portion of a substrate to form a low surface energy surface. The step of depositing a protection layer may be performed on at least a portion of the low surface energy surface. The step of detaching may detach the multi-layer structure from the substrate

### CROSS-REFERENCE TO RELATED APPLICATIONS

This application claims priority under 35 U.S.C. § 119(e) to U.S. Provisional Application Ser. No. 63/185,407 filed on May 7, 2021, the entire disclosure of which is incorporated herein by reference.

### GOVERNMENT SUPPORT

This invention was made with government support under PHY-1549132 awarded by the National Science Foundation. The Government has certain rights in the invention.

### FIELD

A method of forming a multi-layer structure comprising may include a step of providing a substrate, a step of depositing a protection layer, a step of depositing a thin film material, and a step of detaching. The substrate may have a low surface energy surface or a low surface energy coating or modification disposed on at least a portion of a substrate to form a low surface energy surface. The step of depositing a protection layer may be performed on at least a portion of the low surface energy surface. The step of detaching may detach the multi-layer structure from the substrate

### BACKGROUND

Many applications would benefit from the development of brighter electron sources. For example, brighter electron sources might enable ultra-fast electron diffraction (UED) systems to “watch” proteins “respond” in real time. Brighter electrons sources would also benefit laboratory-based x-ray free-electron lasers (FELs). These applications require electron beams, produced by irradiation of a photocathode surface, to be exceptionally bright. In this context, a “bright” electron beam has a high density of electrons all travelling with almost parallel momenta, i.e., with negligible kinetic energy transverse to the propagation direction. Several processes in particle accelerators affect the brightness of an electron beam; however, Liouville's theorem states that the brightness of an electron beam traveling in a linear accelerator can never exceed the initial brightness at the photocathode surface.

Photocathodes are materials that emit electrons when illuminated with light via the photoelectric effect. It would be advantageous if photocathodes could be synthesized using robust materials that could be exposed to air and shared with laboratories around the world. Photocathode design is limited by chemistry: materials that emit electrons easily are easily oxidized. For highest performance, photocathodes are preferably atomically flat and chemically homogeneous, as chemical and physical roughness are known to decrease beam brightness.

Alkali antimonide photocathodes have attractive properties as photoemitters, such as low emittance and high quantum efficiency, which makes them excellent candidates for high-brightness electron sources. Less attractively, these materials are highly reactive and require ultra-high-vacuum conditions to prevent irreversible oxidation. Such limitations have stymied the quantification of the effects of chemical and morphological heterogeneity on performance.

Atomically thin two-dimensional materials, such as single-layer graphene (SLGr) and hexagonal boron nitride (hBN), are impenetrable by even the smallest gas molecules. In addition to forming impenetrable barriers to gas molecules, graphene has been used as a passivation layer to drastically reduce the corrosion rate of metal surfaces in gas and aqueous environments.

Liu et al. used SLGr to protect a copper photocathode; however, their approach required the growth of the SLGr layer in situ. Single-layer graphene grown on copper photocathodes protected the photocathodes from a 3-hr exposure to laboratory air, which was attributed to the impenetrable barrier formed by the SLGr-Cu interface that prevented adsorption of moisture and oxidants. Copper was used as a model system, as single-layer graphene growth typically uses copper foil or single crystal copper as a catalytic surface. This approach is limited to the handful of materials that develop a graphene overlayer when exposed to hydrocarbons at high temperatures. As such, it would be advantageous to develop an approach that could enable any material to be encapsulated in a 2D material.

### SUMMARY

In one aspect, the present disclosure provides a method of forming a multi-layer structure comprising (i) providing a substrate having a low surface energy surface, such as a substrate comprising a low surface energy coating or modification disposed on at least a portion of the substrate to provide a low surface energy surface; and/or (ii) depositing a protection layer on at least a portion of the low surface energy surface, wherein the protection layer is atomically thin and/or atomically smooth; and/or (iii) depositing one or more thin film materials to be protected on the protection layer to provide one or more layers of thin film materials, (i.e. wherein the thin film materials to be protected comprise one or more layers of thin film materials to be protected); and/or (iv) detaching (e.g., peeling) the multi-layer structure from the substrate; wherein the multi-layer structure comprises the protection layer and the thin film materials.

In some embodiments, the method further comprises depositing a capping layer on the thin film material to be protected. In some embodiments, the step of depositing a capping layer occurs prior to step (iv) of detaching described herein. In some embodiments, the multi-layer structure comprises the protection layer, the thin film materials, and the capping layer.

In some embodiments, the method further comprises providing a delamination promoting layer (e.g., a stressed metal film and/or a tape) in contact with the multi-layer structure. In some embodiments, the method further comprises providing a delamination promoting layer (e.g., a stressed metal film and/or a tape) in contact with the multi-layer structure, and pulling the multi-layer structure from the substrate. In some embodiments, the step of providing a delamination promoting layer occurs prior to step (iv) of detaching described herein. In some embodiments, the step of providing a delamination promoting layer occurs prior to step (iv) of detaching described herein and after the step of depositing a capping layer as described herein.

In some embodiments, the low surface energy surface has a surface energy of less than about 50 mJ/m². In some embodiments, the low surface energy surface has a water contact angle of greater than 100°. In some embodiments, the low surface energy surface comprises one or more monolayers of fluorine, fluorinated molecules, or long-chain aliphatic molecules.

In some embodiments, the low surface energy surface comprises an atomically smooth surface having a roughness of less than 1 monolayer of deviation from the mean line. In some embodiments, the low surface energy surface comprises an atomically smooth surface having an average roughness of less than about 2 Å.

In some embodiments, the protection layer comprises one or more materials selected from graphene, graphene oxide, hexagonal boron nitride (hBN), transition metal dichalcogenides (Mo, W, etc. combined with S, Se, or Te), silica SiO₂ or any combination thereof.

In some embodiments, the one or more thin film materials comprise one or more materials selected from photoemissive, photoactive, photosensitive, air-sensitive materials or any combination thereof.

In some embodiments, the one or more photoemissive, photoactive, photosensitive, or air-sensitive materials are selected from Ag, Mg, Cs₃Sb, gallium arsenide (GaAs), alkali antimonides (KₓNa_{y}Rb_{w}Cs₂Sb wherein x+y+w+z is typically 3 and x, y, w, and/or z is >=0), indium gallium arsenide (InGaAs), cesium telluride (CsTe), cesium iodide (CsI) and/or any combination thereof.

In some embodiments, the protection layer is epitaxially grown on the substrate in-situ (e.g., through physical vapor deposition such as sputter deposition or molecular beam epitaxy), or transferred from a source layer; and/or wherein the one or more thin film materials is epitaxially grown in-situ (e.g., through physical vapor deposition such as sputter deposition or molecular beam epitaxy).

In some embodiments, the capping layer is selected from a conducting metal or a semiconducting material, or an insulating material.

In some embodiments, the (average) thickness of the protection layer is in a range of 3 Å to 2 nm (like 2 Å to 2 nm), preferably a range of 3 Å to 6 Å.

In some embodiments, the (average) thickness of the one or more thin film materials is in a range of 1 nm to 1000 nm (like 1 nm to 1000 nm), preferably a range of 40 to 100 nm.

In some embodiments, the (average) thickness of the capping layer is in a range of 1 nm to 1000 nm (like 1 nm to 1000 nm), preferably a range of 20 nm to 500 nm.

In some embodiments, the substrate is selected from metal, metal oxide (e.g., TiO₂), silicon, silicon carbide, polymer (e.g., polyethylene terephthalate), or glass. In some embodiments, the substrate is near-atomically flat.

In some embodiments, the substrate and/or the low surface energy surface comprising substantially no hole and/or no defect in a local surface area, as observed with visual inspection (e.g. observation of the substrate with the naked eye), optical microscope, atomic force microscope (AFM), electron microscope (e.g., SEM or TEM) and/or any combination thereof.

In some embodiments, the detached surface of the multi-layer structure having the protection layer exposed to air or environment, and where the protection layer having no island, and/or no grain on the exposed surface after detaching as observed with naked eyes, optical microscope, AFM, electron microscope (e.g., SEM or TEM) and/or any combination thereof.

According to another aspect of the disclosure, a multi-layer structure comprises a first layer, a second layer, and optionally a third layer. The first layer may be an atomically thin and/or atomically smooth protection layer comprising (substantially) no island and/or no grain exposed to environment as observed by naked eyes, optical microscopes, AFMs, electron microscopes and/or any combination thereof in a local surface area. The second layer may be one or more thin film materials to be protected. The optionally third layer may cap the second layer.

In some embodiments, the second layer comprising one or more materials selected from a photosensitive material, an air sensitive material, an oxygen sensitive material, a material sensitive to an exposing environment or any combination thereof.

In some embodiments, the multi-layer structure is at least a portion of an electrode (e.g., a photocathode).

In some embodiments, the surface between the first layer and the second layer is clean with substantially no contaminants (e.g., no oxidation/oxide, no adventitious carbon).

In some embodiments, the exposed surface of the first layer is clean with substantially no contaminant (e.g., no fluorine, or no adventitious carbon). In some embodiments, the first layer comprises one monolayer, two monolayers, three monolayers or four monolayers of protection material selected from graphene, graphene oxide, hexagonal boron nitride (hBN), transition metal dichalcogenides (Mo, W, etc. combined with S, Se, or Te), silica SiO₂ and/or any combinations thereof.

In some embodiments, the multi-layer structure is a photocathode.

According to another aspect of the disclosure, a photocathode is made of a method described herein, wherein the photocathode is atomically flat and chemically homogeneous, and the photocathode encapsulated by a graphene layer.

In some embodiments, the low surface energy surface has a surface energy of less than about 30 mJ/m².

In some embodiments, the low surface energy surface has a water contact angle of greater than 120°.

Additional embodiments, features, and advantages of the disclosure will be apparent from the following detailed description and through practice of the disclosure. The compounds and methods of the present disclosure can be described as embodiments in any of the following enumerated clauses. It will be understood that any of the embodiments described herein can be used in connection with any other embodiments described herein to the extent that the embodiments do not contradict one another.

1. A method of forming a multi-layer structure comprising:
i) providing a substrate having a low surface energy surface;
ii) depositing a protection layer on at least a portion of the low surface energy surface, wherein the protection layer is atomically thin and/or atomically smooth;
iii) depositing one or more thin film materials on the protection layer to provide one or more layers of thin film materials; and
iv) detaching the multi-layer structure from the substrate;
wherein the multi-layer structure comprises the protection layer and the one or more layers of thin film materials.

2. The method of the preceding clause, wherein the low surface energy surface comprises a low surface energy coating or modification disposed on at least a portion of the substrate.

3. The method of any one of the preceding clauses, wherein the method further comprises, prior to step (iv), depositing a capping layer on the one or more layers of thin film materials.

4. The method of any one of the preceding clauses, wherein the method further comprises, prior to step (iv), providing a delamination promoting layer in contact with the capping layer.

5. The method of any one of the preceding clauses, wherein the delamination promoting layer comprises a stressed metal film or a tape.

6. The method of any one of the preceding clauses, wherein the low surface energy surface has a surface energy of less than about 50 mJ/m².

7. The method of any one of the preceding clauses, wherein the low surface energy surface has a surface energy of less than about 30 mJ/m².

8. The method of any one of the preceding clauses, wherein the low surface energy surface has a water contact angle of greater than 100°.

9. The method of any one of the preceding clauses, wherein the low surface energy surface has a water contact angle of greater than 120°.

10. The method of any one of the preceding clauses, wherein the low surface energy surface comprises one or more monolayers of fluorine atoms, fluorinated molecules, or long-chain aliphatic molecules.

11. The method of any one of the preceding clauses, wherein the low surface energy surface comprises an atomically smooth surface having a roughness of less than 1 monolayer of deviation from the mean line.

12. The method of any one of the preceding clauses, wherein the low surface energy surface comprises an atomically smooth surface having an average surface roughness of less than about 2 Å.

13. The method of any one of the preceding clauses, wherein the protection layer comprises one or more materials selected from the group consisting of graphene, graphene oxide, hexagonal boron nitride (hBN), transition metal dichalcogenides, and silica (SiO₂), or a combination thereof.

14. The method of any one of the preceding clauses, wherein the transition metal dichalcogenide is molybdenum (Mo) or tungsten (W) combined with sulfur (S), selenium (Se), or tellurium (Te).

15. The method of any one of the preceding clauses, wherein the one or more thin film materials are selected from the group consisting of a photosensitive material, a photoemissive material, a photoactive material, an air-sensitive material, an oxygen sensitive material, and a material sensitive to an exposing environment, or a combination thereof.

16. The method of any one of the preceding clauses, wherein the one or more photoemissive, photoactive, photosensitive, or air-sensitive materials are selected from the group consisting of Ag, Mg, Cs₃Sb, gallium arsenide (GaAs), an alkali antimonide, indium gallium arsenide (InGaAs), cesium telluride (CsTe), and cesium iodide (CsI), or a combination thereof.

17. The method of any one of the preceding clauses, wherein the alkali antimonide is of the formula KₓNa_{y}Rb_{w}Cs_{z}Sb wherein each of x, y, w, and z is independently 0, 1, 2, or 3, provided that x+y+w+z is 3.

18. The method of any one of the preceding clauses, wherein step (ii) comprises epitaxially growing the protection layer on the substrate in-situ, or transferring the protection layer from a source layer.

19. The method of any one of the preceding clauses, wherein the source layer is silicon carbide (SiC), a metal thin film of copper (Cu) or gold (Au), or a polymeric thin film of thermal release tape.

20. The method of any one of the preceding clauses, wherein step (ii) comprises epitaxially growing the protection layer on the substrate in-situ by physical vapor deposition or molecular beam epitaxy.

21. The method of any one of the preceding clauses, wherein the physical vapor deposition comprises sputter deposition.

22. The method of any one of the preceding clauses, wherein step (iii) comprises epitaxially growing in-situ the one or more layers of thin film materials.

23. The method of any one of the preceding clauses, wherein step (iii) comprises epitaxially growing in-situ the one or more layers of thin film materials by physical vapor deposition or molecular beam epitaxy.

24. The method of any one of the preceding clauses, wherein the physical vapor deposition comprises sputter deposition.

25. The method of any one of the preceding clauses, wherein the capping layer comprises a conducting metal, a semiconducting material, or an insulating material.

26. The method of any one of the preceding clauses, wherein the protection layer has an average thickness of from about 3 Å to about 2 nm; or about 3 Å to about 6 Å.

27. The method of any one of the preceding clauses, wherein the one or more layers of thin film materials has an average thickness of from about 1 nm to about 1000 nm; or about 40 to about 100 nm.

28. The method of any one of the preceding clauses, wherein the capping layer has an average thickness of from about 1 nm to about 1000 nm; or about 20 nm to about 500 nm.

29. The method of any one of the preceding clauses, wherein the substrate comprises a metal, metal oxide, silicon, silicon carbide, polymer, or glass.

30. The method of any one of the preceding clauses, wherein the metal oxide comprises titanium dioxide (TiO₂), strontium titanate (SrTiO₃), or alumina (Al₂O₃).

31. The method of any one of the preceding clauses, wherein the polymer comprises polyethylene terephthalate, polytetrafluoroethylene (PTFE), or polyethylene.

32. The method of any one of the preceding clauses, wherein the substrate is near-atomically flat.

33. The method of any one of the preceding clauses, wherein the substrate having a low surface energy surface has substantially no hole and/or defect in a local surface area, as observed by visual inspection, optical microscope, atomic force microscope (AFM), electron microscope, or any combination thereof.

34. The method of any one of the preceding clauses, wherein the electron microscope is a scanning electron microscope (SEM) or a transmission electron microscope (TEM).

35. The method of any one of the preceding clauses, wherein the multi-layer structure comprises a surface on the protection layer having no island and/or grain on the exposed surface after the step (iv) of detaching, as observed by visual inspection, optical microscope, AFM, electron microscope, or any combination thereof.

36. The method of any one of the preceding clauses, wherein the electron microscope is a scanning electron microscope (SEM) or a transmission electron microscope (TEM).

37. A multi-layer structure comprising:
i) a protection layer; and
ii) one or more layers of one or more thin film materials;
   wherein the protection layer is atomically thin and/or atomically smooth in a local surface area as observed by visual inspection, optical microscope, AFM, electron microscope, or any combination thereof.

38. The multi-layer structure of the preceding clause, further comprising a capping layer in contact with the one or more layers of one or more thin film materials.

39. The multi-layer structure of any one of the preceding clauses 37 or 38, wherein the one or more layers of one or more thin film materials comprises one or more materials selected from the group consisting of a photosensitive material, a photoemissive material, a photoactive material, an air sensitive material, an oxygen sensitive material, and a material sensitive to an exposing environment, or a combination thereof.

40. The multi-layer structure of any one of the preceding clauses 37 to 39, wherein the photosensitive material, the photoemissive material, the photoactive material, the air-sensitive material, or the oxygen sensitive material is selected from the group consisting of Ag, Mg, Cs₃Sb, gallium arsenide (GaAs), an alkali antimonide, indium gallium arsenide (InGaAs), cesium telluride (CsTe), and cesium iodide (CsI), or a combination thereof.

41. The multi-layer structure of any one of the preceding clauses 37 to 40, wherein the alkali antimonide is of the formula KₓNa_{y}Rb_{w}Cs_{z}Sb wherein each of x, y, w, and z is independently 0, 1, 2, or 3, provided that x+y+w+z is 3.

42. The multi-layer structure of any one of the preceding clauses 37 to 41, wherein the multi-layer structure is at least a portion of an electrode.

43. The multi-layer structure of any one of the preceding clauses 37 to 42, wherein the electrode is a photocathode.

44. The multi-layer structure of any one of the preceding clauses 37 to 43, wherein the surface between the protection layer and the one or more layers of one or more thin film materials is clean with substantially no contaminate.

45. The multi-layer structure of any one of the preceding clauses 37 to 44, wherein the surface between the protection layer and the one or more layers of one or more thin film materials is clean with substantially no oxidation/oxide or adventitious carbon.

46. The multi-layer structure of any one of the preceding clauses 37 to 45, wherein exposed surface of the protection layer is clean with substantially no contaminate.

47. The multi-layer structure of any one of the preceding clauses 37 to 46, wherein the exposed surface of the protection layer is clean with substantially no fluorine or adventitious carbon.

48. The multi-layer structure of any one of the preceding clauses 37 to 47, wherein an exposed surface on the protection layer has no island and/or grain on the exposed surface after the step (iv) of detaching, as observed by visual inspection, optical microscope, AFM, electron microscope, or any combination thereof.

49. The multi-layer structure of any one of the preceding clauses 37 to 48, wherein the electron microscope is a scanning electron microscope (SEM) or a transmission electron microscope (TEM).

50. The multi-layer structure of any one of the preceding clauses 37 to 49, wherein the protection layer comprises one or more materials selected from the group consisting of graphene, graphene oxide, hexagonal boron nitride (hBN), transition metal dichalcogenide, and silica (SiO₂), or a combinations thereof.

51. The multi-layer structure of any one of the preceding clauses 37 to 50, wherein the transition metal dichalcogenide is molybdenum (Mo) or tungsten (W) combined with sulfur (S), selenium (Se), or tellurium (Te).

52. The multi-layer structure of any one of the preceding clauses 37 to 51, wherein the capping layer comprises a conducting metal, or a semiconducting material, or an insulating material.

53. The multi-layer structure of any one of the preceding clauses 37 to 52, wherein the protection layer has an average thickness of from about 3 Å to about 2 nm; or about 3 Å to about 6 Å.

54. The multi-layer structure of any one of the preceding clauses 37 to 53, wherein the one or more layers of the thin film materials has an average thickness of from about 1 nm to 1000 nm; or about 40 to 100 nm.

55. The multi-layer structure of any one of the preceding clauses 37 to 54, wherein the capping layer has an average thickness of from about 1 nm to 1000 nm; or about 20 nm to 500 nm.

56. A multi-layer structure made by the process of any one of clauses 1 to 36, wherein the multi-layer structure is a photocathode.

57. A photocathode comprising a multi-layer structure of any one of clauses 37 to 55, wherein the photocathode is atomically flat and chemically homogeneous, and the photocathode is encapsulated by the protection layer.

### BRIEF DESCRIPTIONS OF THE DRAWINGS

The detailed description particularly refers to the accompanying figures in which:

FIG. 1 is a completed film stack prior to delamination;

FIG. 2 is a delaminated film;

FIG. 3 is Schematic of single-layer graphene transfer to fluorine-terminated TiO₂(110). A thin layer of gold was deposited on a Cu-supported single-layer graphene film. The copper support was then removed using an aqueous etch, and the graphene was then rinsed in H₂O. The Au/SLGr was transferred to an atomically flat substrate and the Au support removed using an additional etch;

FIG. 4 shows a schematic of molecular-beam epitaxy (MBE) growth geometry. The reflection high-energy diffraction (RHEED) gun produced a glancing incidence electron beam. Diffracted beams were imaged with a phosphor screen and recorded using a CCD camera;

FIG. 5 shows a schematic of reflection high-energy electron diffraction (RHEED) geometry. An incident electron beam undergoes diffraction from the sample during growth. The resulting diffraction pattern was measured on a phosphor screen;

FIG. 6 shows a schematic of the photocathode prior to delamination. The photocathode was grown on a near-atomically flat, F—TiO₂(110) substrate covered by a single-layer graphene film. After growth, the photocathode was capped, and a stressed Ni film deposited. Delamination at the F/SLGr interface was promoted by both interfacial charge transfer and the stressed Ni film;

FIG. 7 shows an optical image of single-layer graphene on F—TiO₂(110). Graphene was not deposited on the right-hand side of the crystal. The contrast is due to optical absorption from the graphene monolayer. (b) Raman spectrum of the graphene monolayer;

FIG. 8 shows high-resolution x-ray photoemission spectra of graphene transferred to F—TiO₂(110) (a) C 1s, (b) O 1s, (c) C 1s, and (d) Ti 2p regions. Spectra were collected at 70° emission;

FIG. 9 shows a comparison of X-ray photoemission spectra of graphene transferred using (denoted B) fluorine and (denoted A) mixed formate/acetate monolayers on TiO₂(110). XPS of the (a) C 1s, (b) O 1s region. Spectra were collected at 70° emission;

FIG. 10 shows high-resolution x-ray photoemission spectra of the (a) C 1s and (b) Ag 3d regions of SLGr/Ag exfoliated from F—TiO₂(110);

FIG. 11 shows scanning tunneling microscopy (STM) images of single-layer graphene coated Ag;

FIG. 12 shows a photocurrent of a single-layer graphene encapsulated Mg photocathode as a function of LED power;

FIG. 13 shows reflection high-energy electron diffraction (RHEED) images of (a) rutile TiO₂(110) along the direction and (b) CsSb long the same direction;

FIG. 14 shows representative x-ray photoemission spectra of CsSb grown and transferred under vacuum. Photocathodes were grown on F—TiO₂(110). Spectra were acquired at (left) 70° and normal emission. The dashed lines represent reference energies discussed in the text and in Table 1;

FIG. 15 shows representative STM images of vacuum-transferred CsSb photocathodes grown on SLGr/F—TiO₂. The inset displays rows with a row-row distance 0.8 nm;

FIG. 16 shows x-ray photoelectron spectra of exfoliated, air-exposed CsSb photocathodes grown on SLGr/F—TiO₂ with (left) 70° and (right) normal emission. The dashed lines represent reference energies discussed in the text and summarized in Table 1; and

FIG. 17 shows high-resolution C Is region x-ray photoelectron spectrum of exfoliated, air-exposed CsSb photocathodes grown on SLGr/F—TiO₂. Photoemission spectra were acquired at 70° emission.

### DETAILED DESCRIPTION

Encapsulation of materials in atomically thin membranes poses a significant materials science challenge, thus there is a need for alternative strategies to protect such fragile materials. As described herein, to protect photocathodes from oxidation and degradation, a chemical process has been developed that can produce a near-atomically-flat, photocathode, such as a graphene-encapsulated photocathode. The structures and methods described herein may provide protection of thin film photocathodes from air exposure and poor vacuum environments. In illustrative embodiments, a chemically controlled substrate may include one or more of the properties that it (a) resists contamination, (b) lowers the surface energy of the substrate, and (c) potentially enables epitaxial growth. In illustrative embodiments, the methods described herein may prepare atomically thin protective film, such as a protection layer as described herein (e.g. graphene), to protect one or more layers of thin film materials comprising chemically sensitive thin-film materials from reaction with environmental species (e.g., air, solution) while minimally impeding the transmission of light and electrons.

In illustrative embodiments, the process includes growing one or more layers of thin film materials (such as a photocathode material) on a protection layer (such as a graphene-terminated, near-atomically-flat surface), then encapsulating a surface (such as the backside of the photocathode) in an unreactive material. In some embodiments, the disclosure provides for one or more protected layers of thin film materials (e.g. a now-graphene-protected photocathode) to be delaminated from the growth surface to provide a multi-layer structure. In some embodiments, the process described herein was tested on prototypical metal cathodes that oxidize easily in air. For example, graphene-coated Ag photocathodes grown according to the methods described herein were near-atomically flat and showed no signs of surface oxidation. In some embodiments, Mg photocathodes were exfoliated using the processes described herein. In some embodiments, the multi-layer structures (e.g. photocathodes) as described herein emitted electrons through the protection layer (e.g. a graphene film). In some embodiments, the methods described herein can be applied to CsSb surfaces grown using molecular-beam epitaxy.

In some embodiments methods for forming a multi-layer structures as described herein may include a step of providing a substrate having a low surface energy surface, such as a substrate comprising a low surface energy coating or modification disposed on at least a portion of a substrate to form a low surface energy surface.

In some embodiments, the methods described herein may include a step of depositing a protection layer on at least a portion of the low surface energy surface. In some embodiments, the protection layer is atomically thin and/or atomically smooth.

In some embodiments, the methods described herein may include a step of depositing one or more thin film materials to be protected on the protection layer to provide one or more layers of thin film materials. In some embodiments, the thin film materials to be protected comprise one or more layers of materials to be protected.

In some embodiments, be methods described herein may include a step of detaching (e.g., peeling) a multi-layer structure from a substrate. In some embodiments, the multi-layer structure comprises the protection layer and the thin film materials. In some embodiments, the multi-layer structure comprises the protection layer and the one or more layers of thin film materials.

In some embodiments, the methods described herein include a step of depositing a capping layer on the thin film material to be protected. In some embodiments, the methods described herein include a step of depositing a capping layer on the one or more layers of thin film material. In some embodiments, the multi-layer structure comprises the protection layer, the thin film materials, and the capping layer. In some embodiments, the multi-layer structure comprises a protection layer, one or more layers of thin film materials, and a capping layer.

In some embodiments, the methods described herein further comprise providing a delamination promoting layer (e.g., a stressed metal film and/or a tape) in contact with the multi-layer structure. In some embodiments, the methods described herein further comprise pulling the multi-layer structure from the substrate. In some embodiments, the methods described herein further comprise providing a delamination promoting layer (e.g., a stressed metal film and/or a tape) in contact with the multi-layer structure, and pulling the multi-layer structure from the substrate.

It will be appreciated that the substrate for use in connection with the methods and multi-layer structures described herein is not particularly limited. Suitable substrates include those known in the art that include a low surface energy surface, or those known I the art that can be modified to include a low surface energy surface, such as by a low surface energy coating or modification disposed on at least a portion of the substrate. In some embodiments, the substrate can be selected from metal, metal oxide (e.g., TiO₂), silicon, silicon carbide, polymer (e.g., polyethylene terephthalate), or glass. It will be appreciated that a variety of metal oxides can be used as a substrate in connection with the methods and multi-layer structures described herein. Suitable metal oxides include but are not limited to titanium oxide (TiO₂), strontium titanate (SrTiO₃), alumina (Al₂O₃), and the like. It will be appreciated that a variety of polymers known to one of skill in the art can be used as a substrate in connection with the methods and multi-layer structures described herein. Suitable polymers include but are not limited to polyethylene terephthalate, PTFE (polytetrafluoroethylene), polyethylene, and the like.

It will be appreciated that the low surface energy coating or modification is not particularly limited, and can be any low surface energy coating or modification known in the art that provides a surface energy as described herein. In some embodiments, suitable low surface energy coatings or modifications include but are not limited to fluorine, fluorinated molecules, long-chain aliphatic molecules, and the like.

“Near-atomically flat” is defined as a crystalline material having the majority of atoms in a typical 10×10 nm region being from the same atomic layer+1 (quantified).

In some embodiments, a surface is substantially atomically smooth. In some embodiments, the substantially atomically smooth surface has a roughness of less than 1 monolayer, less than ⅔ monolayer, less than ½ monolayer, less than ⅓ monolayer, less than ¼, ⅕, ⅙, 1/7, ⅛, 1/9, 1/10 monolayer of deviation from the mean line. In some embodiments, the substantially atomically smooth surface has substantially no defect, substantially no hole, and/or substantially no island, no nucleation, or no grain on the surface. In some embodiments, the substantially atomically smooth surface has an average roughness of less than about 10 Å, less than about 8 Å, less than about 5 Å, less than about 2 Å, or less than about 1 Å.

The roughness is measured as a roughness in a local surface area. The holes, defects, islands, and/or grains can be observed or measured in a local surface area. The local surface area can be defined as at least a 1 square micron of surface area, at least a 1 micron×1 micron area, a 2 micron×2 micron area, 5 micron×5 micron area, 10 micron×10 micron area, 50 micron×50 micron area, 100 micron×100 micron area, 500 micron×500 micron area, or a 1 millimeter×1 millimeter area.

Roughness may be evaluated by TEM, SEM, atomic force microscopy (AFM) or any other imaging systems with near atomic level resolution. The roughness may be measured by the average of the vertical deviations of the roughness profile from the mean line. In one example, an atomically smooth layer 120 a may have an average roughness of less than about 2 Å. Roughness may also be measured by the root mean square (RMS) of vertical deviations of the roughness profile from the mean line.

In some embodiments, a low surface energy surface is defined as a surface that exhibits low polarity and a critical surface energy (or surface tension) of less than about 5, about 6, about 7, about 8, about 9, about 10, about 11, about 12, about 13, about 14, about 15, about 16, about 17, about 18, about 19, about 20, about 21, about 22, about 23, about 24, about 25, about 30, about 35, about 40, about 45, about 50, about 55, or about 60 mJ/m² (or mN/m), preferably less than about 10, about 15, about 20, about 25, or about 30 mJ/m² (or mN/m). In some embodiments, the low surface energy surface is defined by a water contact angle of greater than about 100°, about 105°, about 110°, about 115°, about 120°, about 125°, about 130°, about 135°, about 140°, about 145°, about 148°, about 150°, about 151°, about 152°, about 153°, about 154°, about 155°, about 156°, about 157º, about 158°, about 159°, about 160°, about 161º, about 162°, about 163º, about 164°, or about 165°.

In some embodiments, the protection layer is epitaxially grown on the substrate in-situ (e.g., through physical vapor deposition such as sputter deposition or molecular beam epitaxy), or transferred from a source layer; and/or wherein the one or more thin film materials is epitaxially grown in-situ (e.g., through physical vapor deposition such as sputter deposition or molecular beam epitaxy). In some embodiments, the protection layer comprises one or more materials selected from graphene, graphene oxide, hexagonal boron nitride (hBN), transition metal dichalcogenides (Mo, W, etc. combined with S, Se, or Te), silica, SiO₂ or any combination thereof. In some embodiments, the (average) thickness of the protection layer is in a range of 2 Å to 2 nm, or a range of 3 Å to 2 nm, or a range of 2 Å to 15 Å, or a range of 3 Å to 15 Å, or a range of 2 Å to 10 Å, or a range of 3 Å to 10 Å: or a range of 2 Å to 6 Å or a range of 3 Å to 6 Å. It will be appreciated that a variety of source layers can be used in connection with the methods described herein. Suitable source layers include but are not limited to silicon carbide (SIC), a metal thin film of copper (Cu) or gold (Au), a polymeric thin film of thermal release tape, and the like.

In some embodiments, the one or more thin film materials comprise one or more materials selected from photoemissive, photoactive, photosensitive, air-sensitive materials or any combination thereof. In some embodiments, the one or more photoemissive, photoactive, photosensitive, or air-sensitive materials are selected from Ag, Mg, Cs₃Sb, gallium arsenide (GaAs), alkali antimonides (KₓNa_{y}Rb_{w}Cs_{z}Sb wherein x+y+w+z is typically 3 and x, y, w, and/or z is >=0), indium gallium arsenide (InGaAs), cesium telluride (CsTe), cesium iodide (CsI) and/or any combination thereof. In some embodiments, the (average) thickness of the one or more thin film materials is in a range of 1 nm to 1000 nm (like 1 nm to 1000 nm), preferably a range of 40 to 100 nm. In some embodiments, the alkali antimonides can be of the formula KₓNa_{y}Rb_{w}Cs₂Sb wherein each of x, y, w, and z is independently 0, 1, 2, or 3, provided that x+y+w+z is 3. In some embodiments, the alkali antimonides can be of the formula KₓNa_{y}Rb_{w}Cs₂Sb wherein each of x, y, w, and z is independently 0, 1, or 2, provided that x+y+w+z is 3.

In some embodiments, the capping layer is selected from a conducting metal or a semiconducting material, or an insulating material. In some embodiments, the (average) thickness of the capping layer is in a range of 1 nm to 1000 nm, or a range of 10 om to 800 nm, or a range of 15 nm to 600 nm or a range of 20 nm to 500 nm.

In illustrative embodiments, the substrate is near-atomically flat. In some embodiments, the substrate is selected from metal, metal oxide (e.g., TiO₂), silicon, silicon carbide, polymer (e.g., polyethylene terephthalate), or glass.

In illustrative embodiments, the substrate and/or the low surface energy surface comprises substantially no hole and/or no defect in a local surface area, as observed with naked eyes, optical microscope, atomic force microscope (AFM), electron microscope (e.g., SEM or TEM) and/or any combination thereof.

In some embodiments, the detached surface of the multi-layer structure includes a protection layer that is exposed to air or environment. In some embodiments, the protection layer has no island, and/or no grain on the exposed surface after detaching as observed by visual inspection (such as observation with naked eyes, such as using substantially no magnification), optical microscope, AFM, electron microscope (e.g., SEM or TEM) and/or any combination thereof.

A multi-layer structure includes a first layer, a second layer, and an optional third layer. In some embodiments, the multi-layer structure is at least a portion of an electrode (e.g., a photocathode). In some embodiments, the multi-layer structure is a photocathode. In illustrative embodiments, the photocathode is atomically flat and chemically homogeneous, and the photocathode is encapsulated by a graphene layer.

In some illustrative embodiments, a surface between the first layer and the second layer is clean with substantially no contaminate (e.g., no oxidation/oxide, no adventitious carbon). In some illustrative embodiments, an exposed surface of the first layer is clean with substantially no contaminate (e.g., no fluorine, or no adventitious carbon).

In some embodiments, the first layer is an atomically thin and/or atomically smooth protection layer comprising (substantially) no island and/or no grain exposed to environment as observed by naked eyes, optical microscopes, AFMs, electron microscopes and/or any combination thereof in a local surface area. In some embodiments, the first layer comprises one monolayer, two monolayers, three monolayers or four monolayers of protection material selected from graphene, graphene oxide, hexagonal boron nitride (hBN), transition metal dichalcogenides (Mo, W, etc. combined with S, Se, or Te), silica SiO₂ and/or any combinations thereof.

In some embodiments, the second layer of one or more thin film materials to be protected. In some embodiments, the second layer comprises one or more materials selected from a photosensitive material, an air sensitive material, an oxygen sensitive material, a material sensitive to an exposing environment or any combination thereof.

In some embodiments, the third layer caps the second layer.

The multi-layer structure may protect chemically sensitive thin-film materials from reaction with environmental species (e.g., air, solution) while minimally impeding the transmission of light and electrons. This multi-layer structure may be useful for the protection of photocathode materials, but is potentially applicable to many materials.

In illustrative embodiments, the material to be protected is deposited upon the atomically thin film that is supported by a near-atomically-flat substrate. For example, a protected layer forms after the atomically thin protective film.

In illustrative embodiments, the use of a near-atomically-flat supporting substrate enables the growth of protected, near-atomically-flat material.

In illustrative embodiments, the surface energy of the supporting substrate is controlled (e.g., coated with a low surface energy layer), which promotes the transfer of the atomically thin protective film from the initial substrate to the grown material in one piece

In some embodiments, a supporting substrate, such as a TiO₂(110) single crystal, is first coated with a low-surface-energy coating, such as a fluorine monolayer. The surface morphology of the protected thin film will be determined by the morphology of the supporting substrate, thereby enabling morphology control. An atomically-thin film, such as single-layer graphene, is transferred to the supporting substrate in a manner that preserves the cleanliness of the atomically-thin film. The thin-film material to be protected is deposited upon the graphene in vacuum (e.g., by molecular beam epitaxy or sputter deposition). A protective capping layer (e.g., a conducting metal film, such as chromium, for photocathodes) is then deposited using similar means. Finally, a stressed metal film is deposited to promote delamination. The completed stack is shown in FIG. 1.

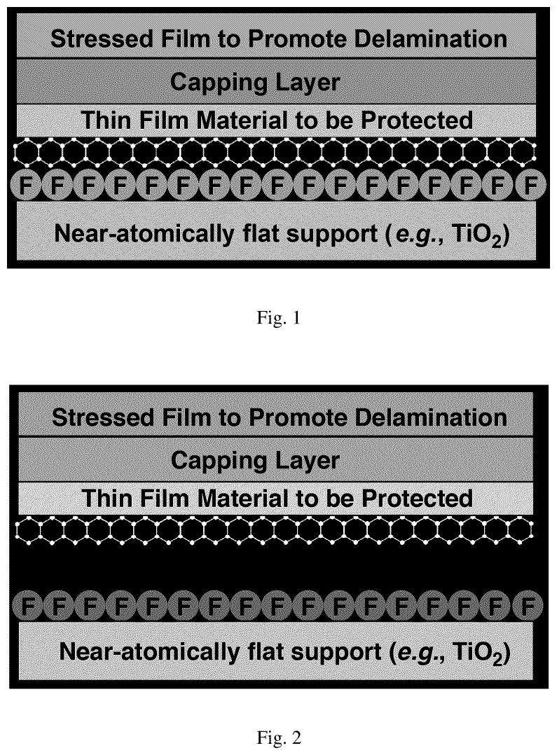

In illustrative embodiments, after fabrication, the protected thin film material is released from the substrate by gently pulling it from the substrate (e.g., with conducting tape). The finished product is shown in FIG. 2.

In some embodiments the method of forming a multi-layer structure comprises providing a substrate having a low surface energy surface or a low surface energy coating or modification disposed on at least a portion of a substrate to form a low surface energy surface; depositing a protection layer on at least a portion of the low surface energy surface and wherein the protection layer is atomically thin and/or atomically smooth; depositing one or more thin film materials to be protected on the protection layer, wherein the thin film materials to be protected comprise one or more layers of materials to be protected; and detaching (e.g., peeling) the multi-layer structure from the substrate; wherein the multi-layer structure comprises the protection layer and the thin film materials.

The method of the preceding embodiment, further comprises depositing a capping layer on the thin film material to be protected, wherein the multi-layer structure comprises the protection layer, the thin film materials and the capping layer.

The method of any one of the preceding embodiments, further comprises providing a delamination promoting layer (e.g., a stressed metal film and/or a tape) in contact with the multi-layer structure, and pulling the multi-layer structure from the substrate.

The method of any one of the preceding embodiments, wherein the low surface energy surface has a surface energy of less than about 50 mJ/m².

The method of any one of the preceding embodiments, wherein the low surface energy surface has a water contact angle of greater than 100°.

The method of any one of the preceding embodiments, wherein the low surface energy surface comprising one or more monolayers of fluorine, fluorinated molecules, or long-chain aliphatic molecules.

The method of any one of the preceding embodiments, wherein the low surface energy surface comprises an atomically smooth surface having a roughness of less than 1 monolayer of deviation from the mean line.

The method of any one of the preceding embodiments, wherein the low surface energy surface comprises an atomically smooth surface having an average roughness of less than about 2 Å.

The method of any one of the preceding embodiments, wherein the protection layer comprises one or more materials selected from graphene, graphene oxide, hexagonal boron nitride (hBN), transition metal dichalcogenides (Mo, W, etc. combined with S, Se, or Te), silica SiO₂ or any combination thereof.

The method of any one of the preceding embodiments, wherein the one or more thin film materials comprise one or more materials selected from photoemissive, photoactive, photosensitive, air-sensitive materials or any combination thereof.

The methodof any one of the preceding embodiments, wherein the one or more photoemissive, photoactive, photosensitive, or air-sensitive materials are selected from Ag, Mg, Cs₃Sb, gallium arsenide (GaAs), alkali antimonides (KₓNa_{y}Rb_{w}Cs_{z}Sb wherein x+y+w+z is typically 3 and x, y, w, and/or z is >=0), indium gallium arsenide (InGaAs), cesium telluride (CsTe), cesium iodide (CsI) and/or any combination thereof.

The method of any one of the preceding embodiments, wherein the protection layer is epitaxially grown on the substrate in-situ (e.g., through physical vapor deposition such as sputter deposition or molecular beam epitaxy), or transferred from a source layer; and/or wherein the one or more thin film materials is epitaxially grown in-situ (e.g., through physical vapor deposition such as sputter deposition or molecular beam epitaxy).

The method of any one of the preceding embodiments, wherein the capping layer is selected from a conducting metal or a semiconducting material, or an insulating material.

The method of any one of the preceding embodiments, wherein the (average) thickness of the protection layer is in a range of 3 Å to 2 nm, preferably a range of 3 Å to 6 Å.

The method of any one of the preceding embodiments, wherein the (average) thickness of the one or more thin film materials is in a range of 1 nm to 1000 nm, preferably a range of 40 to 100 nm.

The method of any one of the preceding embodiments, wherein the (average) thickness of the capping layer is in a range of 1 nm to 1000 nm (like 1 nm to 1000 nm), preferably a range of 20 nm to 500 nm.

The method of any one of the preceding embodiments, wherein the substrate is selected from metal, metal oxide (e.g., TiO₂), silicon, silicon carbide, polymer (e.g., polyethylene terephthalate), or glass.

The method of any one of the preceding embodiments, wherein the substrate is near-atomically flat.

The method of any one of the preceding embodiments, wherein the substrate and/or the low surface energy surface comprising substantially no hole and/or no defect in a local surface area, as observed with naked eyes, optical microscope, atomic force microscope (AFM), electron microscope (e.g., SEM or TEM) and/or any combination thereof.

The method of any one of the preceding embodiments, wherein the detached surface of the multi-layer structure having the protection layer exposed to air or environment, and where the protection layer having no island, and/or no grain on the exposed surface after detaching as observed with naked eyes, optical microscope, AFM, electron microscope (e.g., SEM or TEM) and/or any combination thereof.

In some embodiments a multi-layer structure comprises: a first layer of an atomically thin and/or atomically smooth protection layer comprising (substantially) no island and/or no grain exposed to environment as observed by naked eyes, optical microscopes, AFMs, electron microscopes and/or any combination thereof in a local surface area; a second layer of one or more thin film materials to be protected; and optionally a third layer capping the second layer.

The multi-layer structure of the preceding embodiment, wherein the second layer comprises one or more materials selected from a photosensitive material, an air sensitive material, an oxygen sensitive material, a material sensitive to an exposing environment or any combination thereof.

The multi-layer structure of any one of the preceding embodiments wherein the multi-layer structure is at least a portion of an electrode (e.g., a photocathode).

The multi-layer structure of any one of the preceding embodiments, wherein surface between the first layer and the second layer is clean with substantially no contaminate (e.g., no oxidation/oxide, no adventitious carbon).

The multi-layer structure of any one of the preceding embodiments, wherein exposed surface of the first layer is clean with substantially no contaminate (e.g., no fluorine, or no adventitious carbon).

The multi-layer structure of any one of the preceding embodiments, wherein the first layer comprising one monolayer, two monolayers, three monolayers or four monolayers of protection material selected from graphene, graphene oxide, hexagonal boron nitride (hBN), transition metal dichalcogenides (Mo, W, etc. combined with S, Se, or Te), silica SiO₂ and/or any combinations thereof.

A multi-layer structure made of any one of the preceding embodiments, wherein the multi-layer structure is a photocathode.

A photocathode made by process of any one of the preceding embodiments, wherein the photocathode is atomically flat and chemically homogeneous, and the photocathode encapsulated by a graphene layer.

The method of any one of the preceding embodiments, wherein the low surface energy surface has a surface energy of less than about 30 mJ/m².

The method of any one of the preceding embodiments, wherein the low surface energy surface has a water contact angle of greater than 120°.

### EXAMPLES

### Example 1

### Deposition of Graphene on TiO₂(110)

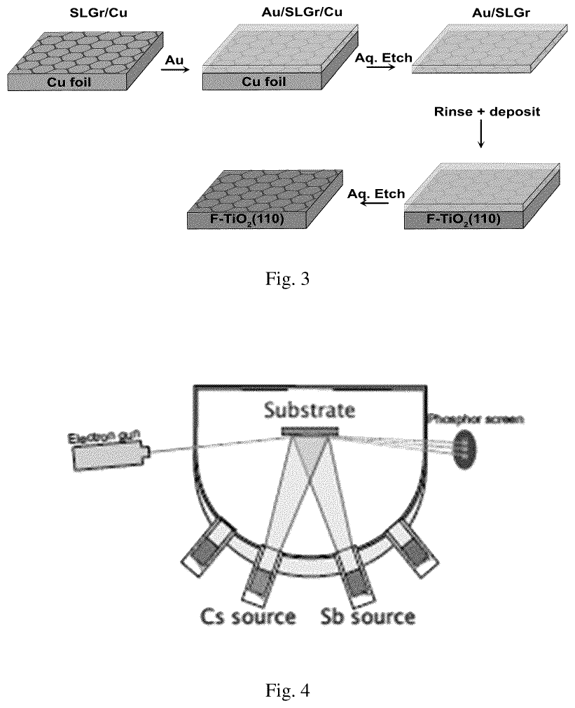

Commercial single-layer graphene (SLGr) samples grown on Cu foil (GrollTeX) were coated with 35 nm of Au in a CVC SC4500 thermal evaporation system with a base pressure of 1×10⁻⁷ Torr. Graphene on the backside of the Cu foil was removed using 100 W of O₂ plasma for 2 min in a YES CV200RFS Oxygen Plasma Asher. The copper foil was removed by gently floating the gold-coated graphene on a 100 mM aq. solution of ammonium persulfate (NH₄S₂O₈ VWR, >99%) for 1 hr. The floating Au-coated graphene was scooped onto a clean glass microscope slide then gently floated on H₂O in a clean recrystallization dish. This process was repeated with three separate aliquots of H₂O to remove residual etchant. The gold-coated graphene was transferred to a F-terminated TiO₂(110) single crystal prepared using the methods in Ch 6 and allowed to dry at room temperature for 1 hr. The film-covered substrate was then heated in air for 30 min at 150° C. on a hotplate to promote adhesion to the substrate by removing interfacial water. The gold film was then removed from the graphene by immersing the substrate into an aqueous etchant (Gold etch TFA, Transene) for 5 min followed by rinsing in H₂O. The graphene-coated substrate was markedly hydrophobic upon removal from water. This process is schematically shown in FIG. 3.

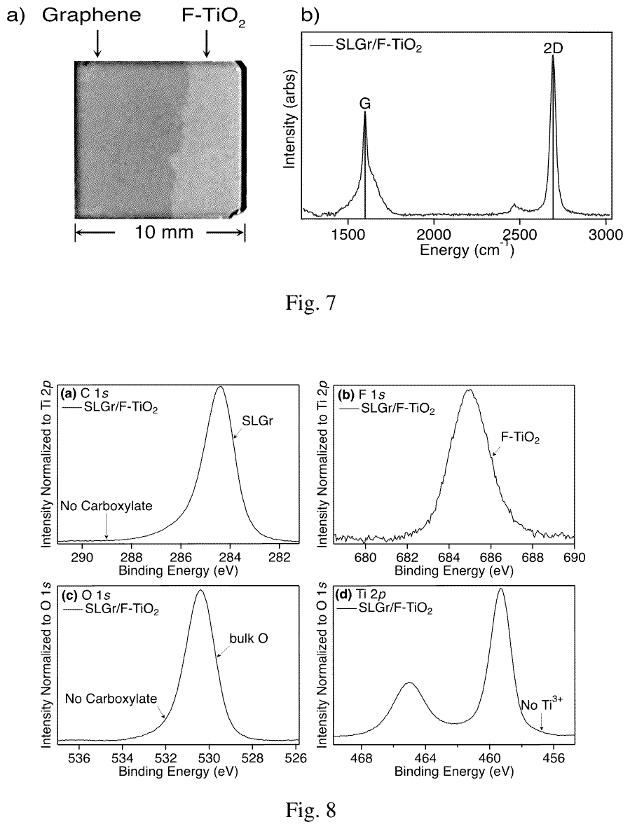

An optical image of graphene-coated TiO₂(110) is shown in FIG. 7a. In this experiment, graphene was transferred only to the left half of the transparent substrate. The graphene monolayer caused a small decrease in the transmission of visible light. In experiments where photocathodes were exfoliated, graphene was deposited on the entire crystal.

The presence and integrity of single-layer graphene after the transfer to F—TiO₂ was confirmed using Raman spectroscopy. As shown in FIG. 7b, graphene-terminated F—TiO₂(110) displayed Raman transitions at 1599.4 cm⁻¹ and 2692.3 cm⁻¹ which were assigned to the 2D and G modes. The ratio of the 2D to G transitions was consistent with previously published spectra of single-layer graphene.

The chemical identity and cleanliness of the as-deposited SLGr/F—TiO₂(110) was verified using XPS analysis. As seen in FIG. 8a, high-resolution scans of the C Is region on the as-deposited graphene monolayer displayed a single, prominent transition at 284.5 eV, which was assigned to sp² hybridized carbon in the graphene lattice. Adventitious carbon, which has a slightly higher binding energy at 286 eV, was not observed. There were no transitions at higher binding energies associated with adsorption of atmospheric organic acids. Further evidence of the cleanliness of the surface came from high-resolution scans of the O 1s region, seen in FIG. 8c. This spectrum was dominated by bulk O atoms in the TiO₂ lattice at 530.5 eV. The absence of atmospheric organic acid contamination was confirmed by the absence of a high-energy shoulder at 532.5 eV. Finally, high-resolution scans of the Ti 2p region showed two transitions assigned to bulk Ti in TiO₂; there was no evidence of oxygen vacancies.

To examine the effects of the TiO₂ surface termination on the resulting interface, single-layer graphene was transferred to chemically etched TiO₂. F—TiO₂ is nearly free of carbon contamination, whereas chemically etched TiO₂ is terminated by a mixed formate/acetate monolayer self-assembled monolayer. Results from these two surface preparations are compared in FIG. 9a. High-resolution scans of the C Is region of chemically etched TiO₂ (denoted B) displayed two transitions, one at 289 eV that was assigned to carboxylates from organic acid adsorption and a second at 284.9 eV that was assigned to the graphene layer. There was a ˜1 eV shift in binding energy from graphene transferred to F—TiO₂ vs organic acid-terminated TiO₂. These spectra show that the use of a F-terminated TiO₂ crystal leads to the production of a substantially less contaminated supported film. Further evidence of contamination from organic acids came from high-resolution scans of the O 1s region shown in the light gray (denoted A) spectrum in FIG. 9b. The spectrum was dominated by bulk oxygen; however, etched crystals displayed a pronounced shoulder in the high binding energy region that was assigned to carboxylate. Taken together, these spectra indicate that using F—TiO₂ as a substrate results in cleaner surfaces, free of contamination.

### Example 2

### Deposition of Ag and Ni Films

Graphene-terminated F—TiO₂(110) crystals were introduced into a SC4500 thermal/e-beam deposition system at the Cornell Nanofabrication Facility (CNF). The deposition apparatus consists of a bell jar evacuated by a cryopump to high vacuum. Silver (Lesker, 99.99%) and nickel (Lesker, >99.99%) were placed in a Ti crucible (Lesker), then the substrates were placed in a custom aluminum sample holder and evacuated. When the pressure reached 1×10⁻⁶ Torr, deposition rates were calibrated using a quartz crystal microbalance followed by metal deposition. Silver was thermally deposited at 5 Ås⁻¹. Nickel films were deposited (50-100 nm thick) on top of the Ag, Mg, or CsSb to induce stress throughout the film. This thickness was chosen to be one-half of the thickness necessary to spontaneously delaminate the film after growth.

Ag films were deposited using thermal evaporation on SLGr/F—TiO₂(110) and then capped with Ni using electron-beam evaporation to induce strain in the Ag film. After the films were removed from the growth system, they were transported to another building, exfoliated using carbon tape, and immediately introduced into the UHV analysis chamber through an oil-free load lock.

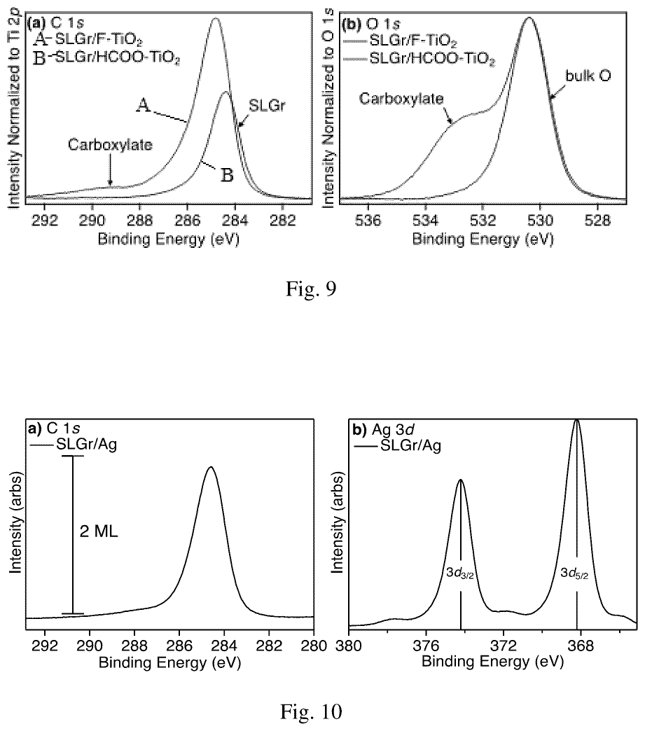

Chemical analysis of the Ag films showed no evidence of oxidation. As seen in FIG. 10a, the C Is region displayed a single prominent transition at 284.5 eV consistent with binding energies of graphene-coated F—TiO₂(110). The intensity of the C Is transition was nearly twice that of single-layer graphene, which was attributed to accidental transfer of graphene monolayers from both the front and backside of the Cu substrate. High-resolution scans of the Ag 3d region were dominated by a pair of Ag⁰ transitions: Ag 3d_{5/2} at 368.3 eV and Ag 3d_{3/2} at 372.2 eV. The binding energies of the Ag 3d transitions were consistent with metallic Ag.

STM images of the exfoliated single-layer-graphene-coated Ag films were atomically smooth. As seen in FIG. 11a, Ag films were atomically flat with ˜3 Å-high steps, which is close to the step heights measured on Ag(111). The hexagonal habit of the vacancy islands and straight step edges were also consistent with the growth of primarily Ag{111} films. This was consistent with previous observations of Ag(111) thin film growth.

### Example 3

### Molecular-Beam Epitaxy of CsSb

Single-layer-graphene-terminated F—TiO₂(110) crystals were mounted on a custom 1 niobium sample holder using an ultrahigh vacuum-compatible Pelco High-Performance Ag paste (Ted Pella) and cured at 90° C. for 30 min in a vacuum furnace before introducing into a Veeco GEN 10 molecular-beam growth apparatus. Substrates were introduction to a growth module using a quick-entry load lock equipped with oil-free pumping. The growth module consisted of a storage chamber with a base pressure of ˜3×10⁻¹⁰ Torr and a growth chamber with a base pressure of 1×10⁻⁹ Torr. The chambers were separated by a gate valve. Immediately prior to growth, substrates were degassed in vacuum by annealing to 600° C. for 20 min and then allowed to cool before growth.

CsSb thin films were grown by MBE using Sb₄ and Cs—In eutectic sources at PARADIM (The Platform for the Accelerated Realization, Analysis, and Discovery of Interface Materials) at Cornell University. The growth geometry is schematically shown in FIG. 4. Sb₄ was supplied using an effusion cell charged with Sb, whereas Cs was deposited from an effusion cell containing Cs—In eutectic. The Cs—In eutectic was prepared by combining 65 g of In with 18.81 g of Cs in an Ar glovebox. The mixture was then heated to 185° C. for 20 min in a Ti crucible. Cs and In fluxes were calibrated using a quartz crystal microbalance and set to 2.5 and 0.4×10¹³ atoms/(s·cm²), respectively. Growths were performed immediately after source calibration with a substrate temperature of 129° ° C. in a base pressure of ˜3×10⁻⁹ Torr. The pressure in the growth system increased as the sources were heated. When the pressure approached ˜7×10⁻⁹ Torr, the background gases were analyzed with a residual gas analyzer which showed that H₂ was the dominant species.

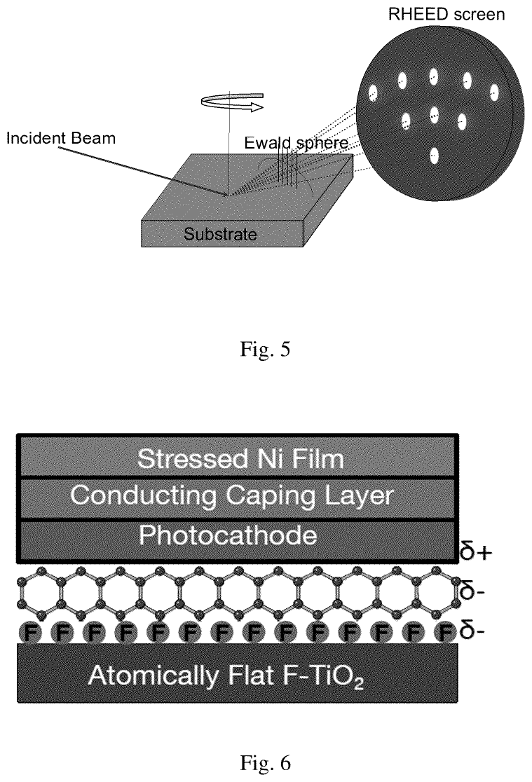

Films grown using molecular-beam epitaxy were continuously monitored using reflection high-energy electron diffraction (RHEED) as shown schematically in FIG. 5.5. Prior to growth, substrate RHEED patterns were used to calibrate the azimuthal angle of the substrate. During growth, RHEED patterns were initially recorded along the calibration azimuth, and then the sample was slowly rotated during growth. The electron beam was turned off for most of the growth.

### Example 4

### Exfoliation of Graphene Encapsulated Films

This example demonstrates a method to produce atomically flat, graphene-protected photocathodes from potentially any material, as shown in FIG. 6. First, near-atomically flat thin films were produced by deposition on a near-atomically flat TiO₂ surface covered by a single-layer graphene film. After deposition, the oxidation-sensitive films were protected by a capping layer, such as Cr. Delaminating the SLGr-protected photocathode from the supporting substrate was addressed with two steps. First, the SLGr film was deposited on a low surface energy, nearly contamination-free substrate: The F-terminated substrate Coulombic effects promoted delamination at the F/SLGr interface. The F-terminated surface was expected to have a partial negative charge. Similarly, the strongly electron-donating photocathode material will donate negative charge to the graphene film, as shown by the partial charges in FIG. 6. The charge donation was also calculated using DFT in previous work. Second, delamination was promoted by the deposition of a stressed Ni film on top of the capping layer.

To ensure film delamination, nickel films with high tensile stress were deposited on the top of the capped photocathode. Nickel was evaporated at 1 Ås⁻¹ to a thickness of 50 nm. Photocathodes were exfoliated by pressing a clean 10×10 mm Si wafer with Kapton or carbon double-sided tape against the Ni/Cr-capped photocathode. The photocathode film was exfoliated by placing a clean razor blade between the Si and photocathode-coated TiO₂ crystal and gently rotating until the film exfoliated onto the Si substrate. When conductive tape was used, samples were exfoliated and immediately introduced to the UHV chamber and analyzed using XPS and STM. Films exfoliated using high-performance Ag paste (PELCO, Ted Pella) were cured at 90° C. for 30 min on a hotplate in air before exfoliation and introduction to UHV.

### Example 5

Photoemission from Mg Films

As a second test of the graphene encapsulation technique, 100 nm of Mg were grown on SLGr/F—TiO₂. After growth, the Mg film was removed from vacuum and then 50 nm of Ni deposited at a rate of 1 Ås⁻¹. After Ni deposition, the film was exfoliated using carbon tape by the methods described in above. After exfoliation, the film was introduced into UHV for characterization.

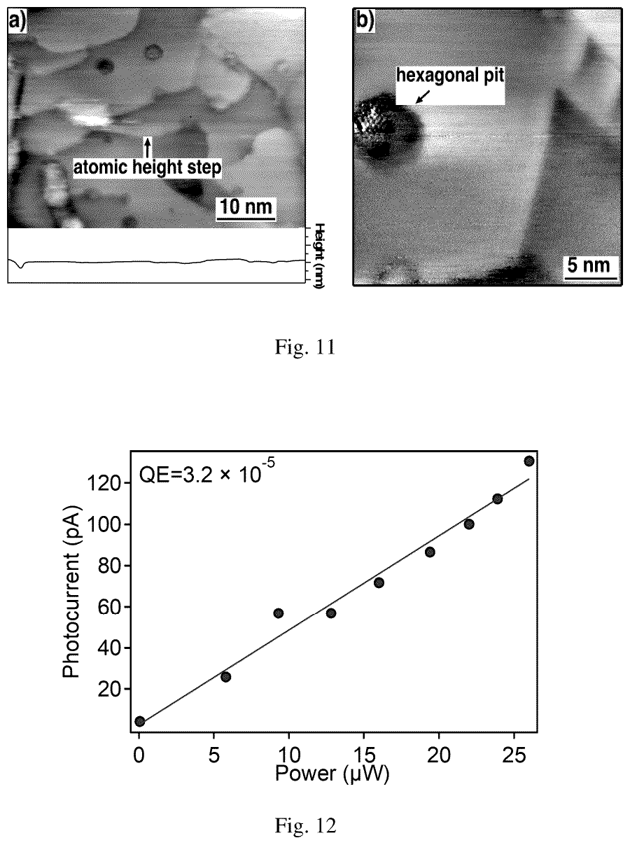

The photocurrent of the SLGr-coated Mg film was measured by biasing the sample at −18 V and illuminating the surface with a 250 nm UV diode array (ThorLabs LED250J) and measuring the drain current using lock-in techniques. The diode current was varied from 0.2-95 mA. The light passed through three aspheric lenses resulting in a source image of the LED array on the sample. After photocurrent acquisition, a power meter was placed in front of the LED source, equidistant from the sample to measure the power as a function of diode current. The photocurrent as a function of LED power is shown in FIG. 12. The measured photocurrent was linear with respect to diode power and the quantum efficiency was calculated to be 3.2×10⁻⁵.

### Example 6

### CsSb Films

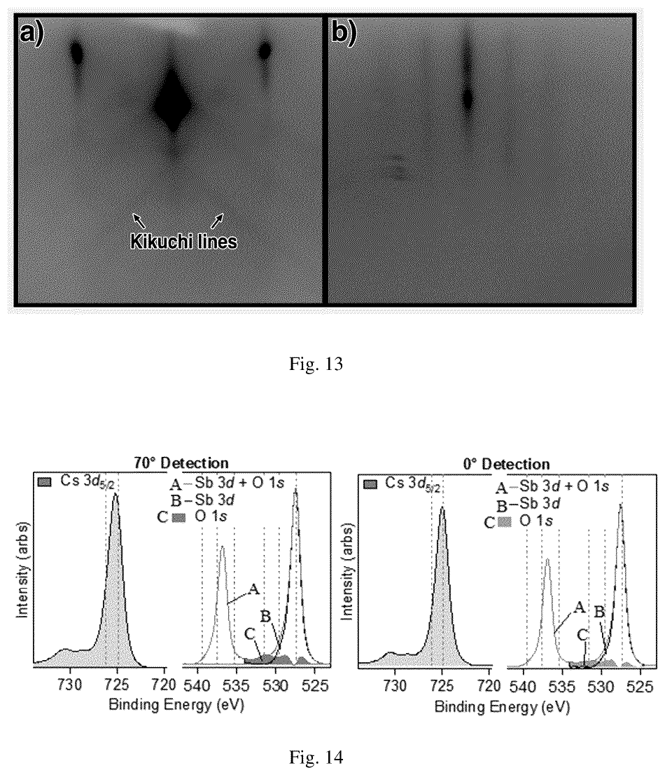

In this Example, CsSb films were grown on SLGr/F—TiO₂(110) using molecular-beam epitaxy. As shown in FIG. 13, RHEED images acquired at glancing incidence along the [110] azimuth display strong secondary diffraction spots with Kikuchi lines, which originate from secondary inelastic scattering of electrons from atomic layers below the topmost layer of the ordered crystal. The combination of diffraction spots and lines indicated the presence of well-ordered surfaces over large length scales.

The appearance of vertical streaks in FIG. 13 indicated the growth of a flat surface. The RHEED pattern was invariant with sample rotation, which suggested the growth of a flat, polycrystalline film.

The chemical composition of the CsSb photocathodes was analyzed using x-ray photoemission spectroscopy. Representative high-resolution photoelectron spectra of the Cs 3d_{5/2} (gray), Sb 3d (denoted B), and O 1s (denoted C) of vacuum-transferred CsSb photocathodes are shown in FIG. 14. The spectra in the left panel were acquired at 70° emission angles and are more surface sensitive. Spectra in the right panel were obtained at normal emission and are less surface sensitive.

There is an overlap between the Sb 3d_{5/2} and O 1s transitions. Raw O 1s spectra were obtained by subtracting the Sb 3d_{5/2} transition using the degeneracies of the Sb 3d spin-orbit states (2:3) and the experimentally verified spin-orbit splitting of 9.35 eV. In the spectra in FIG. 14, the raw Sb 3d+O 1s transitions are shown by line A, whereas the computationally subtracted Sb 3d and O 1s are shown by line B and line C, respectively.

All crystals displayed an intense Sb 3d_{5/2} transition near 525.4 eV which was assigned to Sb¹⁻ in CsSb, as shown in FIG. 14. Spectra of vacuum-transferred crystals were vertically homogeneous, only displaying a small oxide transition in glancing detection. Spectra of vacuum-transferred crystals were otherwise similar in binding energy and intensity.

Vacuum-transferred samples displayed a strong Cs 3d_{5/2} transition in the range 725.1-725.3 eV which we attributed to Cs⁺ in CsSb and cesium oxides. Previous researchers have assigned the Cs⁰ transition to 726.2 eV and Cs⁺ to 724.9 eV. The assignment was not made primarily on binding energy, but also came from the line shape of the Cs 3d spectra. Elemental Cs has a strikingly triangular line shape that was not observe in the spectra.

Vacuum-transferred samples displayed a small degree of oxidation, as indicated by the extracted O 1s transition (denoted C) in FIG. 14. The surface oxide was attributed to cesium oxides. Cesium easily oxidizes to form superoxides (O₂²⁻), peroxides (O₂⁻), and oxides (O²⁻). Each of these species have characteristic binding energies which were assigned by Jupille et al. The surfaces of vacuum-transferred CsSb crystals displayed a small superoxide transition at 531.6 eV.

The Cs:Sb stoichiometry was measured to be 1:1.25 at 70° emission and 1:1.2 at 0° emission. Stoichiometries were calculated from the integrated intensity of the Cs 3d_{5/2} and Sb 3d_{3/2} transitions correcting for the difference in photoemission cross-section of Cs and Sb. Taken together, these spectra show that the vacuum-transferred photocathodes are homogeneous CsSb and have trace amounts of surface cesium superoxide that is not present in the bulk.

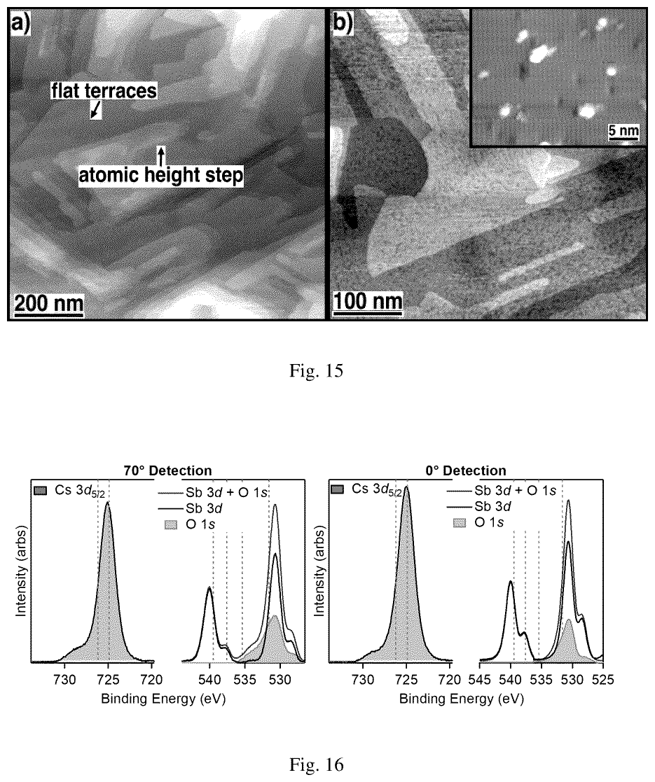

CsSb photocathodes were atomically smooth. STM images, shown in FIG. 15, displayed atomically flat terraces over hundreds of nanometers with step heights of 0.60 nm. The inset in FIG. 15b shows rows separated by 0.8 nm.

CsSb films that were grown on SLGr-covered F—TiO₂(110) were first capped with a 100 nm thick Cr layer in the MBE growth system. The substrate was kept at room temperature during Cr deposition. Cr-capped CsSb films were then removed from vacuum and capped with 50 nm of Ni using electron-beam evaporation to induce strain in the underlying CsSb film. The crystal was exfoliated by pressing a clean 10×10 mm Si wafer with Kapton double-sided tape against the Ni-coated Cr-capped CsSb. The CsSb film was exfoliated by placing a clean razor blade between the Si and CsSb-coated TiO₂ crystal and gently rotating until the film exfoliated onto the Si substrate. The Si crystal with the exfoliated CsSb was mounted and loaded into UHV for chemical characterization using XPS. The film appeared grey and lost its metallic sheen within the 2-5 min required for loading. The XPS spectra are shown in FIG. 16. Only one film was exfoliated.

The exfoliated CsSb displayed an intense Sb 3d_{3/2} transition near 539.5 eV which was assigned to antimony oxide. It was not possible to distinguish between Sb³⁺ (e.g., Sb₂O₃) or Sb⁵⁺ (e.g., Sb₂O₅ or CsSbO₃). Spectra also have a small shoulder near 537.6 eV that was assigned to Sb⁰. The exfoliated CsSb crystal displayed an intense Cs 3d_{5/2} transition in the range 725.0-725.1 eV, which was attributed to Cs⁺ in cesium superoxides (O₂²⁻), Cs peroxides (O₂⁻), and Cs oxides (O²⁻). Exfoliated films displayed significant oxidation, as shown in the O 1s transitions shaded in light gray, which are a combination of cesium oxides and oxygen-containing contaminants resulting from air exposure. Taken together, the spectra of exfoliated CsSb indicate that the film was oxidized and contained antimony and cesium oxides.

TABLE 1
Reference binding energies used throughout the text.

| Energy (eV) | Species | Energy (eV) | Species |
|---|---|---|---|
| 527.4 | O²⁻ | 537.6 | Sb⁰ |
| 529.6 | O₂²⁻ | 539.5 | Sb⁵⁺ |
| 531.6 | O₂⁻ | 724.9 | Cs⁺ |
| 525.4 | Sb⁻ | 726.2 | Cs⁰ |

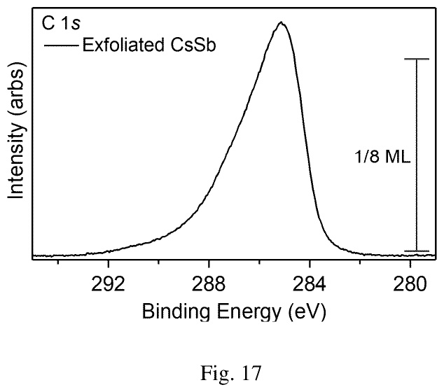

The C 1s spectra showed that most of the graphene films was removed by the exfoliation process. As shown in FIG. 17, high-resolution scans of the C 1s region displayed an asymmetric transition, centered at 285 eV that extends to 292 eV. There was a 500 mV shift from single-layer graphene measured on Cu and Ag. The C 1s transition displayed an asymmetric tail that extends to ˜292 eV, indicating the presence of oxidized C species such as alcohols or carboxylic acids. The intensity of the C 1s transition was one-eighth of a monolayer compared to monolayer graphene measured on Cu as indicated by the scale bar in FIG. 17.

### Example 7

Exfoliation of the graphene-protected CsSb crystal was unsuccessful, as evidenced by the oxidation of both Cs and Sb and the partial graphene monolayer. SLGr/F—TiO₂ was heated to 625° C. to degas the substrate prior to growth. This was likely the cause of failure. 60% of the F desorbs when heated to 650° C. The generation of F₂ (g) likely pressurized the graphene layer and perforated the graphene layer, resulting in the partial exfoliation and destruction of the film.

Exfoliation of Ag and Mg films were successful. Ag films were atomically flat and did not display oxidation. Using the same procedure, the first extraction of photoelectrons through the graphene layer on Mg was demonstrated. The F—TiO₂(110) substrate was not heated prior to exfoliation. These results indicate that the integrity of the F-monolayer for exfoliation of the graphene may be important.

A CsSb photocathode was discovered. The CsSb is atomically flat and chemically homogeneous, which is attractive due to its potential for low-emittance. X-ray diffraction and DFT calculations may identify structural and photophysical properties.

A technique is described herein for the production of graphene-protected photocathodes. This method may be applicable to any materials because it does not rely on the growth of the graphene on the photocathode. Graphene-protected Ag and Mg were grown on and exfoliated from a clean F—TiO₂ substrate. The first photoelectrons through a graphene-encapsulated photocathode were measured.

1. A method of forming a multi-layer structure comprising:
i) providing a substrate having a low surface energy surface;
ii) depositing a protection layer on at least a portion of the low surface energy surface, wherein the protection layer is atomically thin and/or atomically smooth;
iii) depositing one or more thin film materials on the protection layer to provide one or more layers of thin film materials; and
iv) detaching the multi-layer structure from the substrate;
wherein the multi-layer structure comprises the protection layer and the one or more layers of thin film materials.

2. The method of claim 1, wherein the low surface energy surface comprises a low surface energy coating or modification disposed on at least a portion of the substrate.

3. The method of claim 1, wherein the method further comprises, prior to step (iv), depositing a capping layer on the one or more layers of thin film materials.

4. The method of claim 3, wherein the method further comprises, prior to step (iv), providing a delamination promoting layer in contact with the capping layer.

5. The method of claim 4, wherein the delamination promoting layer comprises a stressed metal film or a tape.

6. The method of claim 1, wherein the low surface energy surface has a surface energy of less than about 50 mJ/m².

7. The method of claim 1, wherein the low surface energy surface has a water contact angle of greater than 120°.

8. The method of claim 1, wherein the low surface energy surface comprises one or more monolayers of fluorine atoms, fluorinated molecules, or long-chain aliphatic molecules.

9. The method of claim 1, wherein the low surface energy surface comprises an atomically smooth surface having a roughness of less than 1 monolayer of deviation from the mean line.

10. The method of claim 1, wherein the protection layer comprises one or more materials selected from the group consisting of graphene, graphene oxide, hexagonal boron nitride (hBN), transition metal dichalcogenides, and silica (SiO₂), or a combination thereof.

11. The method of claim 10, wherein the transition metal dichalcogenide is molybdenum (Mo) or tungsten (W) combined with sulfur (S), selenium (Se), or tellurium (Te).

12. The method of claim 1, wherein the one or more thin film materials are selected from the group consisting of a photosensitive material, a photoemissive material, a photoactive material, an air-sensitive material, an oxygen sensitive material, and a material sensitive to an exposing environment, or a combination thereof.

13. The method of claim 12, wherein the one or more photoemissive, photoactive, photosensitive, or air-sensitive materials are selected from the group consisting of Ag, Mg, Cs₃Sb, gallium arsenide (GaAs), an alkali antimonide, indium gallium arsenide (InGaAs), cesium telluride (CsTe), and cesium iodide (CsI), or a combination thereof.

14. The method of claim 13, wherein the alkali antimonide is of the formula KₓNa_{y}Rb_{w}Cs_{z}Sb wherein each of x, y, w, and z is independently 0, 1, 2, or 3, provided that x+y+w+z is 3.

15. The method of claim 1, wherein step (ii) comprises epitaxially growing the protection layer on the substrate in-situ, or transferring the protection layer from a source layer.

16. The method of claim 15, wherein the source layer is silicon carbide (SIC), a metal thin film of copper (Cu) or gold (Au), or a polymeric thin film of thermal release tape.

17. The method of claim 16, wherein step (ii) comprises epitaxially growing the protection layer on the substrate in-situ by physical vapor deposition or molecular beam epitaxy.

18. The method of claim 17, wherein the physical vapor deposition comprises sputter deposition.

19. A multi-layer structure comprising:
i) a protection layer; and
ii) one or more layers of one or more thin film materials;
wherein the protection layer is atomically thin and/or atomically smooth in a local surface area as observed by visual inspection, optical microscope, AFM, electron microscope, or any combination thereof.

20. The multi-layer structure of claim 19, further comprising a capping layer in contact with the one or more layers of one or more thin film materials.
